(19) United States
(12) Patent Application Publication
(10) Pub. No.: US 2024/0239565 A1
(43) Pub. Date: Jul. 18, 2024

(54) FLUID PRODUCT DISPENSER

(71) Applicant: APTAR FRANCE SAS, LE NEUBOURG (FR)

(72) Inventors: Jean-Paul LECOUTRE, CONDE SURITON (FR); Alex MILIAN, LES BAUX DE BRETEUIL (FR)

(73) Assignee: APTAR FRANCE SAS, LE NEUBOURG (FR)

(21) Appl. No.: 18/290,228

(22) PCT Filed: May 10, 2022
(86) PCT No.: PCT/FR2022/050894

§ 371 Date: Nov. 10, 2023

(30) Foreign Application Priority Data
May 11, 2021 (FR) FR2104974

(51) Int. Cl. B65D 47/18; B05B 1/02; B05B 11/10

(52) U.S. Cl. CPC B65D 47/18; B05B 1/02; B05B 11/1002

(57) ABSTRACT

Fluid product application device having a base part mounted on a main reservoir and having a dip tube connecting a cup provided with a piston lip, and a removable member mounted on the base part and having a tube able to slide against the piston lip and an applicator able to retain a dose of fluid product injected by suction generated by the tube sliding in a sealed manner against the piston lip. The fluid product is injected into the applicator through the dip tube, the removable member further having a nipple communicating with the applicator and the dip tube. The nipple internally defines a secondary fluid product reservoir for supplying the applicator with fluid product.

The present invention relates to a fluid product application device that makes it possible to apply a fluid product to a target surface with the aid of an applicator. Fluid product is transferred from the applicator, which forms an integral part of the fluid product dispenser by putting the applicator into contact with the target surface, which surface may, for example, be the skin of a user of the dispenser. The fluid product may be of low viscosity, such as perfume, but preferably, it will be a more viscous fluid product, such as oil or serum.

In the prior art, document U.S. Pat. No. 10,806,232 B2 is known, which describes a fluid product application device comprising a base part mounted on a fluid reservoir, the base part comprising a dip tube that connects a cup provided with a piston lip. The application device also comprises a removable member mounted in a removable manner along a sliding axis on the base part. The removable member comprises a tube or pipette that is able to slide along a sliding axis in a fluid-tight manner against the piston lip over a fluid-tight axial stroke and an applicator that is able to retain a dose of fluid product coming from the reservoir by suction generated by the fluid-tight sliding of the tube against the piston lip: the applicator is formed in the tube. Thus, the fluid would be injected into the applicator through the dip tube. The removable member further comprises a nipple communicating with the applicator and the dip tube.

In this document U.S. Pat. No. 10,806,232 B2, there is no provision for sucking fluid into the applicator using the nipple, which is only provided for expelling the fluid that has been sucked into the applicator during fluid-tight sliding. In any case, in this applicator device of the prior art, it would only be possible to make fluid product rise in the applicator, given that the volume of the nipple is much smaller than the cumulative volumes of the applicator and the dip tube.

An objective of the present invention is to define a fluid product application device with greater freedom of application. Another objective is to create a novel operational gesture for loading the applicator.

To this end, the present invention proposes a fluid product dispenser comprising:
a base part mounted on a main fluid product reservoir, the base part comprising a dip tube connecting a cup provided with a piston lip, and
a removable member that is mounted on the base part in a removable manner, the removable member comprising a tube able to slide in a fluid-tight manner against the piston lip over a fluid-tight axial stroke, and an applicator able to retain a dose of fluid product injected by suction generated by the fluid-tight sliding of the tube against the piston lip, the applicator being formed in the tube, the fluid being injected into the applicator through the dip tube, the removable member further comprising a nipple communicating with the applicator and the dip tube,

characterized in that the nipple internally defines a secondary fluid reservoir for supplying the applicator with fluid.

Thus, the removable member has its own reservoir, once it has been removed from the base part. This provides greater freedom for the applicator, which can be supplied from the secondary reservoir by flattening the nipple. This novel function conferred upon the nipple clearly distinguishes it from the overall teaching of document U.S. Pat. No. 10,806,232 B2.

Advantageously, the nipple defines a useful actuation volume that corresponds to the difference between its maximum volume at rest and its minimum volume after maximum flattening, this useful volume being greater than the volume of the applicator by a minimum of approximately 2 to 4 times, advantageously by approximately 4 to 5 times, and preferably by more than 5 times. Thus, the removable member may have a reserve of refill doses for the applicator. The user can constantly and gently flatten the nipple by pressing in order to continuously supply the applicator.

In accordance with one aspect of the invention, the removable member defines an axial height Ho and the applicator defines an axial height Ha, Ha preferably being at most equal to half of Ho. In accordance with another aspect of the invention, the applicator defines an axial height Ha and the nipple defines an axial height Ht, Ha advantageously being at most equal to and preferably less than Ht. In short, the applicator of the invention is short compared with a conventional applicator, such as that of U.S. Pat. No. 10,806,232 B2, which could be described as an elongated pipette, the length of which corresponds to approximately twice that of the nipple. Because the user grasps and manipulates the removable member by the nipple, the precision of application decreases as the nipple is lengthened. However, by reducing the length of the applicator, although the precision of application is increased, its capacity, and therefore the quantity of fluid product to be applied, is reduced. In order to overcome this disadvantage, the invention endows the nipple with a secondary reservoir function, that of a reservoir, which will supply the “short” applicator, during the application phases, during which the removable member is, of course, separated from the main reservoir. In other words, the reservoir integrated into the nipple makes it possible to compensate for the disadvantage associated with the reduced length of the applicator, which offers good precision upon application.

In accordance with an advantageous feature of the invention, an extension tube may extend from the bottom of the cup in the extension of the dip tube in the direction of the nipple when the removable member is in place on the base part. Advantageously, the extension tube comes into the proximity of or even in contact with the nipple when the removable member is in place on the base part. In accordance with one embodiment, the nipple comprises an inlet defining a seat, the extension tube comprising a free upper end that can come into fluid-tight contact with the seat of the nipple. Thus, whether or not the extension tube comes into contact with the nipple, it makes it possible to neutralize at least part of the volume of the applicator during filling of the nipple with fluid product. In fact, the fluid present in the applicator around the extension tube may be considered to be a dead volume, given that it is located in the dead end closed by the piston lip. When the nipple is flattened, only the volume located between the free end of the extension tube and the inlet of the nipple will be evacuated through the dip tube: the dead volume remains inactive. For this reason, the closer the extension tube is to the inlet of the nipple, the less volume there is to evacuate. When the extension tube is in contact with the nipple, there is only the volume of the extension tube to be evacuated into the applicator.

In accordance with another advantageous feature of the invention, the nipple defines a useful actuation volume that corresponds to the difference between its maximum volume at rest and its minimum volume after flattening, this useful volume being greater than the cumulative volumes of the dip tube and the extension tube by a minimum of approximately 2 to 4 times, advantageously by approximately 4 to 5 times, and preferably by more than 5 times. This means that the secondary reservoir of the nipple can hold more than five times more than the dip tube and the extension tube combined.

In accordance with another aspect of the invention, the extension tube may occupy more than 50% of the volume of the applicator, advantageously more than 75% of the volume of the applicator, and preferably more than 90%. Total occupancy is ideal, but only in theory. An occupancy of more than 90% is already highly satisfactory.

In accordance with a practical embodiment, the extension tube may be formed integrally with the cup or with the dip tube. It is even possible to envisage the dip tube with integral extension tube being slidably mounted in the cup in order to ensure that the extension tube comes into proper contact with the inlet of the nipple.

The present invention also defines a method for filling a fluid product applicator as defined above, the method comprising the following steps in succession:
a) flattening the nipple then releasing it in order to suck fluid product from the main reservoir into the secondary reservoir of the nipple, and
b) removing the removable member from the base part in order to fill the applicator by sucking fluid product from the main reservoir and/or the secondary reservoir.

Thus, the operation of flattening and releasing the nipple, when the removable member is in place on the base part, does not serve to fill the applicator, but the secondary reservoir defined by the nipple. Filling of the applicator is independent of the nipple since this is carried out by suction when the removable member is removed. Then, during application of the fluid product, the nipple is used to supply the applicator with fluid product from the secondary reservoir.

The concept of the invention resides in using the nipple as a fluid reservoir that will supply the applicator during the application of the fluid, and not as suction means for filling the applicator.

The invention will now be described more fully with reference to the accompanying drawings, given by way of non-limiting example, of three embodiments of the invention with two variations.

In the figures:

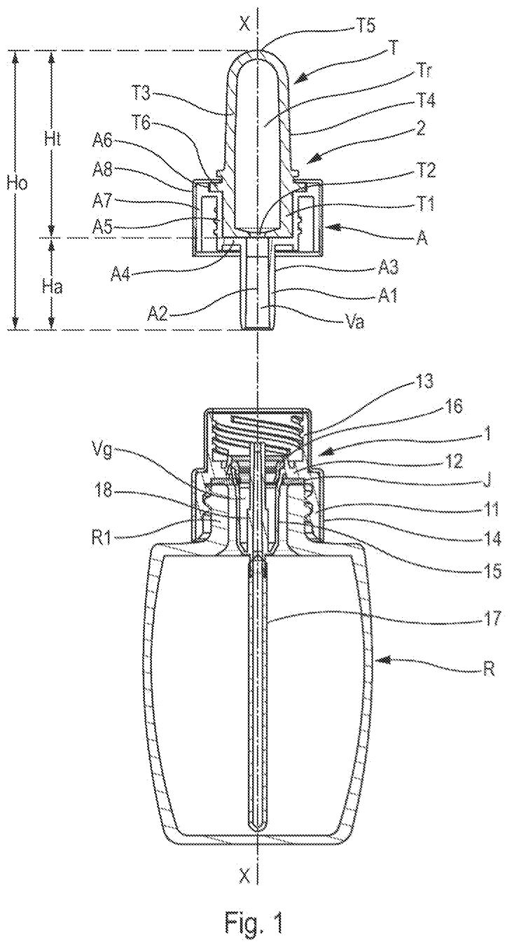

FIG. 1 is an exploded vertical sectional view through a fluid product application device in accordance with a first non-limiting embodiment of the invention,

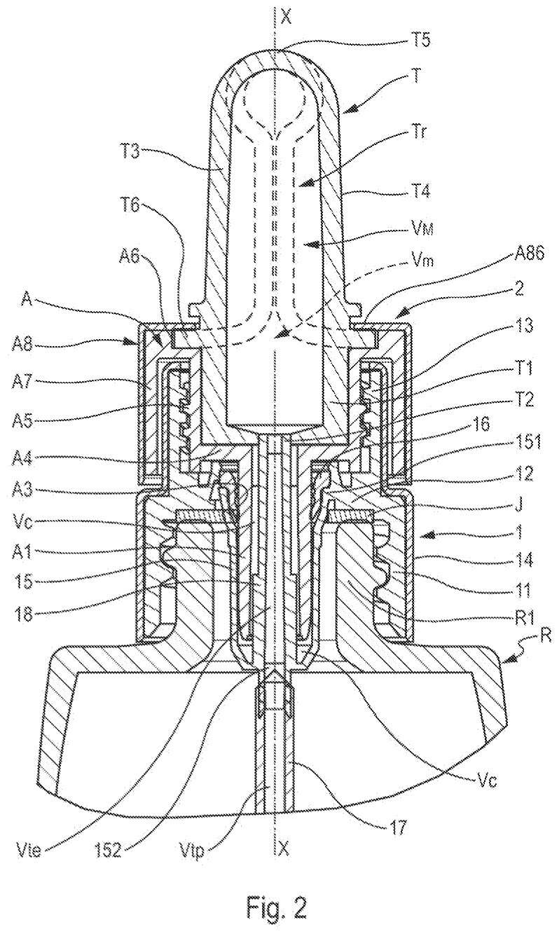

FIG. 2 is an enlarged view of the application device of FIG. 1 in its assembled state,

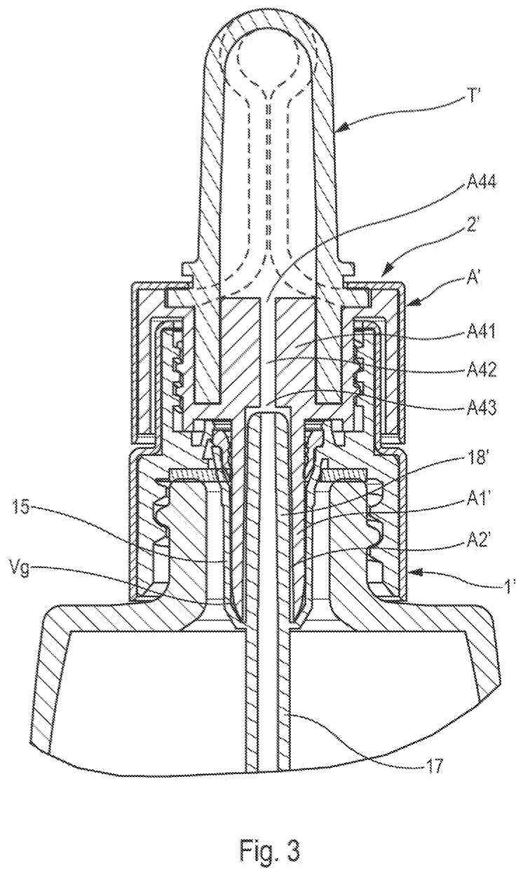

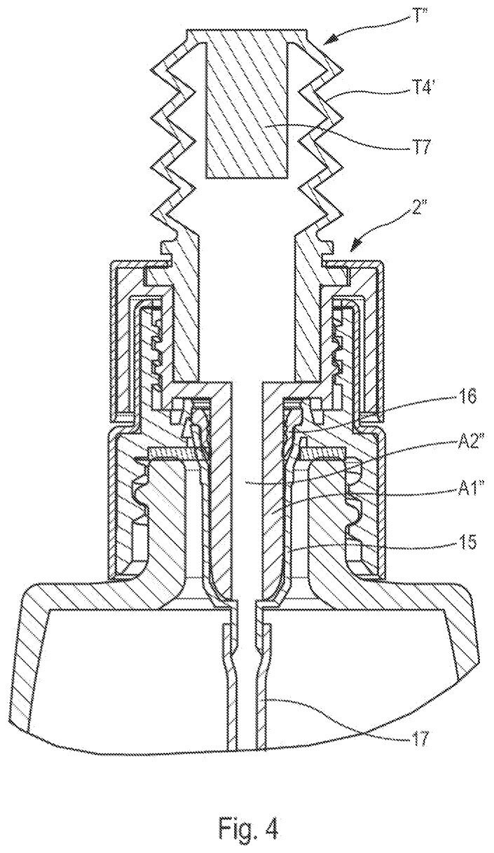

FIGS. 3 and 4 respectively show two other embodiments of the invention.

Firstly, the volumes defined below should be understood to mean the capacity of the elements and not the volumes of the constituent material of the elements, unless expressly specified. As an example, Va is the volume inscribed inside the applicator: this volume Va can be filled with fluid product.

Reference is made below to FIGS. 1 and 2 in order to describe a non-limiting first embodiment of the invention. The fluid product application dispenser of the invention comprises a main fluid product reservoir R, which may be of any kind and any shape. It comprises an opening, generally in the form of a neck R1. The main reservoir R is not an element which is critical to the present invention.

The fluid product application device further comprises two main constituent elements, namely a fixed base part 1 and a removable member 2. The base part 1 is intended to be mounted in a fixed and fluid-tight manner on the neck R1 of the main reservoir R. The removable member 2 is mounted in a removable manner on the base part 1.

The base part 1 comprises a fastening skirt 11 intended to cooperate with the main reservoir R in order to fasten the base part 1 to the main reservoir R in a stable and fluid-tight manner. The fastening skirt 11 may, for example, comprise fastening heads intended to engage with an appropriate profile formed by the neck R1 of the main reservoir R. It is also possible to envisage forming the fastening skirt 11 with an internal thread intended to cooperate with an external thread formed by the neck R1 of the main reservoir R. Here again, the type of fastening technique for mounting the fastening skirt 11 on the reservoir R is not critical in respect of the present invention. The fixed base part 1 also comprises an annular plate 12 which may optionally serve to flatten a neck seal J on the annular upper edge of the neck R1 of the main reservoir R. The base part 1 also forms a bushing 13 which is internally threaded. The base part 1 may be provided with an outer casing 14 that surrounds the skirt 11 and the bushing 13 and comes into contact with the main reservoir R.

The base part 1 also forms a cup 15 that is connected to the plate 12 by extending into the neck R1 of the main reservoir R. The cup 15 defines a wide upper opening 151 and a small lower orifice 152. At its upper opening 151, the cup 15 forms or is provided with a piston lip 16, which advantageously points downwards and inwards. At its lower orifice 152, the cup 15 forms or is provided with a dip tube 17, which extends downwards into the main reservoir R as far as its bottom. Still at its lower orifice 152, the cup 15 forms or is provided with an extension tube 18, which extends upwards inside the cup 15 as far as its upper opening 151, and even beyond. This extension tube 18 extends substantially or completely in the extension and alignment of the dip tube 17. The extension tube 18 is made integrally with the cup 15, but it could also be formed integrally with the dip tube 17. In this case, the extension tube 18 would be an upper portion of the dip tube 17 that extends into the cup 15. It can be seen that the lower orifice 152 forms the junction between the dip tube 17 and the extension tube 18.

Thus, a cup volume Vg is defined in the cup around the extension tube 18, which defines a volume Vte. The dip tube 17 defines a volume Vtp.

The movable member 2 essentially comprises two constituent parts, namely an applicator element A and a nipple T, which are fixedly connected to one another. The applicator element A is preferably produced from a hard material, while the nipple T is produced from a flexible material, since it is intended to be flattened by the user, for example between their thumb and index finger.

The applicator element A comprises a tube A1 that internally defines an applicator A2 with volume Va, and externally an external sliding surface A3, intended to come into fluid-tight sliding contact with the piston lip 16. The tube A1 extends axially downwards from the inner periphery of an annular flange A4, which therefore forms a protruding collar at the upper end of the tube A1. The outer periphery of the flange A4 is connected to a ring A5 that is externally threaded and is adapted to come into threaded engagement with the threaded bushing 13. At its upper end, the ring A5 forms a housing A6 the function of which will be explained below. The ring A5 is surrounded by a gripping ring A7. The applicator element A is provided with a hoop A8 which is turned inwards at A86 to close the housing A6.

The nipple T comprises an anchoring projection T1 that forms an inlet T2. The anchoring projection T1 is received in the ring A5 and abuts against the flange A4. The inlet T2 may restrict the upper opening of the tube A1. The projection T1 forms a fastening collar A6 which is received in the housing A6 and held in place by the inward turn A86 of the hoop A8. Beyond the anchoring projection T1, the nipple T forms a bulb T3, the function of which is to be flattened between the user's fingers. This bulb defines a peripheral wall A4 and an upper wall A5. The user will exert finger pressure on opposite faces of the peripheral wall A5. The flattened state is shown in FIG. 2 by dashed lines. As will be seen below, the nipple T functions as a secondary reservoir Tr, the useful actuation or suction volume Vu of which corresponds to the difference between the maximum volume VM of the nipple in the rest state (shown in solid lines in FIG. 2) and the minimum volume Vm of the nipple in the completely flattened state (shown in dashed lines in FIG. 2). The VM/Vm ratio is preferably greater than 4.

In FIG. 1, the removable member 2 is separated or removed from the base part 1 mounted on the reservoir R. In FIG. 2, the removable member 2 is in place on the base part 1, with the tube A1 engaged in the cup 15 around the extension tube 18 and the threaded ring A5 engaged with the threaded bushing 13. More precisely, the external sliding surface A3 is in fluid-tight contact with the piston lip 16 and the free end of the extension tube 18 is in fluid-tight contact with the inlet T2 of the nipple T, which therefore forms a seat: the extension tube 18 is therefore directly connected to the nipple T by shunting the cup 15. It is thus possible to define a closed volume Vc which extends either side of the tube A1, from the piston lip 16 to the inlet T2 closed by the extension tube 18. It can be said that Vc is equal to Va minus the volume of the constituent material of the tube A1 and the extension tube 18 minus Vte. Moreover, it should be noted that the extension tube 18 occupies more than 50% of the volume Va of the applicator A2, advantageously more than 75% and preferably about 90%.

In accordance with the invention, in this embodiment, Vu>Vte+Vtp. Advantageously, 2(Vte+Vtp)<Vu<4(Vte+Vtp). More advantageously, 4(Vte+Vtp)<Vu<5 (Vte+Vtp). It is even possible that Vu>5(Vte+Vtp). By way of non-limiting example, Vu=600 mm³, Vtp=90 mm³, Vte=30 mm³ and Va=120 mm³.

Furthermore, the removable member 2 defines an axial height Ho and the tube A2 or the applicator A2 defines an axial height Ha:Ha<Ho/2. In addition, the nipple T defines an axial height Ht:Ht>Ha.

The application device operates in the following manner, starting from the assembled state of FIG. 2, in which the nipple T, the dip tube 17 and the extension tube 18 are empty of fluid product.

Firstly, the user starts by grasping the nipple at its peripheral wall T4 and exerting pressure with a thumb and index finger. The air present in the nipple T, the dip tube 17 and the extension tube 18 is then expelled into the reservoir R. The user then releases the pressure on the nipple T, which will return to its initial rest position because of its elastic shape memory. In doing so, fluid is sucked into the nipple T through the dip tube 17 and the extension tube 18. The nipple T is then partially filled with fluid. This is possible because Vu is greater than Vte+Vtp, and preferably much greater, by up to more than 5 times. And since Vu is greater than Va, and preferably much greater, by up to more than 5 times, the secondary reservoir Tr of the nipple T is filled with a quantity of fluid that corresponds to several doses for the applicator A2.

In a second step, the user unscrews the removable member 2, thereby causing the tube A1 to slide in a fluid-tight manner in the piston lip 16. Simultaneously, the contact between the inlet T2 of the nipple T and the extension tube 18 is interrupted, such that the closed volume Vc then communicates with the secondary reservoir Tr and the extension tube 18. The fluid-tight sliding generates a vacuum that will suck fluid product into the applicator, the volume of which is increasing. The fluid product comes from the main reservoir R or from the secondary reservoir Tr, or from both reservoirs at the same time, in proportions that are dependent on the pressure drops of the flows. In all cases, the applicator A2 is thus filled, with a few more doses in reserve in the nipple T.

The user can then apply the fluid product as desired by bringing the free end of the tube A1 into contact with the target (skin, nail, hair, etc.). During application, the nipple is gently and continuously pressed in order to deliver the fluid from the secondary reservoir Tr into the applicator A2.

Once the nipple T has been emptied of its fluid product, the user puts the movable member 2 back in place on the base part 1 by first engaging the tube A1 around the extension tube 18 and screwing the threaded ring A5 into the threaded bushing 13. As soon as the tube A1 comes into fluid-tight sliding contact with the piston lip 16, the air and fluid product contained in the cup 15, the extension tube 18 and the dip tube 17 are delivered into the main reservoir R. The end of screwing up corresponds to the engagement of the extension tube in the inlet T2 of the nipple T. The starting position of FIG. 2 is then re-attained. It should be noted that it is not necessary to screw the mobile member 2 in completely in order to refill the nipple T. in fact, as soon as the tube A1 comes into fluid-tight contact with the piston lip 16, the nipple T can be flattened and its elastic resilience will suck fluid product from the main reservoir R into the nipple T.

FIG. 3 shows a second embodiment of the invention, in which the base part 1′ differs from the first embodiment in that the cup 15, the dip tube 17 and the extension tube 18′ are in one piece. In addition, the extension tube 18′ occupies more than 90%, or even 95%, of the volume Va of the applicator A2′, which is formed by a tube A1′, which occupies more than 90%, or even 95%, of the volume Vg of the cup 15. The free end of the tube A1′ comes into contact or almost into contact with the bottom of the cup 15. Thus, the free volume remaining in the cup 15 is minimal. It should also be noted that the extension tube 18′ is separated from the nipple T′ by a channel A42, which is formed by an insert A41 of the applicator element A′. This insert A41 extends into the nipple T′ in a manner such as to reduce its dead volume. The channel A42 defines an inlet A43 that communicates directly with the applicator A2′ and an outlet A44 that communicates directly with the nipple T′. It should be noted that the duct A42 extends in the extension and alignment of the extension tube 18′, but there is no contact between the extension tube 18′ and the insert A41: they are separated by a distance of the order of a few tenths of a millimeter, or even one or two millimeters. Thus, even in the rest position, the nipple T′ and the extension tube 18′ communicate with the residual volume defined on either side of the tube A1′.

The function of this variation is identical to that of the first embodiment in FIGS. 1 and 2. The absence of fluid-tight contact between the extension tube 18′ and the duct A42 does not perturb the filling of the nipple T′ at all, given that the residual volume is very small and constitutes a dead end.

Here again, Vu is greater than the cumulative volumes of the dip tube 17, the extension tube 18′ and the conduit A42. Vu may be more than 5 times greater than these cumulative volumes. Similarly, the removable member 2′ defines an axial height Ho and the tube A1′ or the applicator A2′ defines an axial height Ha:Ha<Ho/2. In addition, the nipple T′ defines an axial height Ht:Ht>Ha.

The embodiment of FIG. 4 differs from the preceding embodiments, firstly in that there is no extension tube. The applicator A1″ is empty and fills the cup 15 to more than 90%. It directly connects the dip tube 17 to the nipple T″, which comprises a bellows T4′ and an internal stud T7 to reduce the dead volume of the nipple T″, such that the useful actuation volume Vu is close to the maximum volume at rest. The user presses on the upper wall of the internal stud T7.

Here again, Vu is greater than the cumulative volumes of the dip tube 17 and the applicator A1″. Vu may be more than 5 times greater than these cumulative volumes. Similarly, the removable member 2′ defines an axial height Ho and the tube A1″ or the applicator A2″ defines an axial height Ha:Ha<Ho/2. In addition, the nipple T″ defines an axial height Ht:Ht>Ha, which makes it possible to have a short applicator with increased application accuracy.

It should be noted that the piston lip 16 could possibly be omitted in this variation.

In all of the embodiments, the nipple functions as a secondary reservoir in order to supply the applicator during the application operation. To this end, the cumulative volumes of the elements upstream of the nipple are smaller than the useful suction volume of the nipple. The fluid-tight sliding of the tube in the piston lip makes it possible to fill the applicator once the nipple has been filled. The use of the extension tube allows for optimal filling of the nipple by reducing, or even neutralizing, the dead or closed volumes of the cup.

Without departing from the scope of the invention, the nipple could be flattened by an intermediate element on which the user will act: the pressure would therefore no longer be exerted directly on the nipple by the user.

The invention therefore provides a fluid product application distributor the movable member of which may contain several doses in order to supply the applicator. This removable member can be compared with or likened to a nomadic dispenser that is attached to a source bottle in order to refill its own reservoir.

1. A fluid product application device, comprising:
a base part mounted on a main fluid product reservoir, the base part comprising a dip tube connecting a cup provided with a piston lip, and
a removable member that is mounted on the base part in a removable manner, the removable member comprising a tube able to slide in a fluid-tight manner against the piston lip over a fluid-tight axial stroke, and an applicator able to retain a dose of fluid product injected by suction generated by the fluid-tight sliding of the tube against the piston lip, the applicator being formed in the tube, the fluid being injected into the applicator through the dip tube, the removable member further comprising a nipple communicating with the applicator and the dip tube,
characterized in that the nipple internally defines a secondary fluid reservoir for supplying the applicator with fluid.

2. The application device as claimed in claim 1, in which the nipple defines a useful actuation volume Vu that corresponds to the difference between its maximum volume at rest and its minimum volume after maximum flattening, the applicator defines a volume Va, the useful volume Vu being greater than the volume Va of the applicator by a minimum of approximately 2 to 4 times, advantageously by approximately 4 to 5 times, and preferably by more than 5 times.

3. The application device as claimed in claim 1, in which the removable member defines an axial height Ho, the applicator defines an axial height Ha, Ha being at most equal to half of Ho.

4. The application device as claimed according to claim 1, in which the applicator defines an axial height Ha and the nipple defines an axial height Ht, Ha being at most equal to and preferably less than Ht.

5. The application device as claimed according to claim 1, in which an extension tube extends from the bottom of the cup in the extension of the dip tube in the direction of the nipple when the removable member is in place on the base part.

6. The application device as claimed in claim 5, in which the extension tube comes into the proximity of the nipple when the removable member is in place on the base part.

7. The application device as claimed in claim 6, in which the nipple comprises an inlet defining a seat, the extension tube comprising a free upper end that comes into leak-tight contact with the seat of the nipple.

8. The application device as claimed in claim 5, in which the nipple defines a useful actuation volume Vu that corresponds to the difference between its maximum volume at rest and its minimum volume after flattening, this useful volume Vu being greater than the cumulative volumes of the dip tube and the extension tube by a minimum of approximately 2 to 4 times, advantageously by approximately 4 to 5 times, and preferably by more than 5 times.

9. The application device as claimed according to claim 5, in which the extension tube occupies more than 50% of the volume of the applicator, advantageously more than 75% of the volume of the applicator, and preferably approximately 90%.

10. The application device as claimed according to claim 5, in which the extension tube is formed integrally with the cup with the dip tube.

11. A method for filling a fluid product application device as claimed according to claim 1, comprising the following steps in succession:
a) flattening the nipple, then releasing it in order to suck fluid from the main reservoir into the secondary reservoir of the nipple, and
b) removing the removable member from the base part in order to fill the applicator by sucking fluid product from the main reservoir and/or the secondary reservoir.
